(19) United States
(12) Patent Application Publication
(10) Pub. No.: US 2006/0036084 A1
(43) Pub. Date: Feb. 16, 2006

(54) Conglomerated semiconductor nanocrystals

(76) Inventor: Lianhua Qu, Pittsburgh, PA (US)

Correspondence Address: Debra M. Parrish;Suite 200, 615 Washington Road, Pittsburgh, PA, 15228, US

(21) Appl. No.: 11/197,650

(22) Filed: Aug. 4, 2005

Related U.S. Application Data
(60) Provisional application No. 60/598,635, filed on Aug. 4, 2004.

(51) Int. Cl. C01B 23/00

(52) U.S. Cl. 534/7

(57) ABSTRACT

The present invention is directed to compositions comprising conglomerated semiconductor nanocrystals, methods of making conglomerated semiconductor nanocrystals, and methods of using conglomerated semiconductor nanocrystals. Conglomerated semiconductor nanocrystals can be prepared by agitation in solutions comprising one or more nonpolar solvents, or by crosslinking to a variety of polymers. The invention also includes methods of preparing hydrophilic conglomerated semiconductor nanocrystals by enclosing them within a hydrophilic polymer “cage.” Conglomerated semiconductor nanocrystals are useful in a variety of fluorescence based detection systems.

This application claims the benefit of and priority from U.S. provisional application Ser. No. 60/598,635, filed Aug. 4, 2004.

### FIELD OF THE INVENTION

The present invention relates to novel fluorescent materials called conglomerated semiconductor nanocrystals, methods of making conglomerated semiconductor nanocrystals, and methods of using conglomerated semiconductor nanocrystals.

### BACKGROUND OF THE INVENTION

Semiconductor nanocrystals or semiconductor quantum dots (SCNs) are simple inorganic solids typically consisting of a hundred to a hundred thousand atoms. They emit spectrally resolvable energies, have a narrow symmetric emission spectrum, and are excitable at a single wavelength. SCNs can be used in fluorescence based detection systems, and offer distinct advantages over conventional dye molecules. For example, SCNs can be made to emit multiple colors of light, fluoresce with high quantum yield, and provide discrete emission spectra peaks.

SCNs are of considerable interest due to their unique size-dependent properties that are not available from either discrete atoms or bulk solids. Methods of making SCNs have been documented by Murray et al. (JACS 115:8706 (1993)), Qu et al. (JACS 124:2049 (2002), Nanoletters 1:333 (2001), and Nanoletters 4:465 (2004)), Danek et al. (Materials 8(1): 173 (January 1996)), Hines and Guyot-Sionnest (J. Phys. Chem. 100:468 (January 1996)), and Xinhua Zhong et al. (JACS 125:8589 (2003) and JACS 125:12559 (2003)).

However, SCNs disclosed in the prior art are chemically fragile, which has limited their adoption in many applications. The present invention provides a novel material that is more chemically resilient than single nanocrystals, methods for preparing such nanocrystals, and methods of using such nanocrystals.

### SUMMARY OF THE INVENTION

The present invention comprises a method for preparing conglomerated SCNs. According to the invention, SCNs can be made to pack together into one or more conglomerated SCNs. The invention uses SCNs as a starting reagent to produce a plurality of SCNs bound together in a single mass or clump. The resulting conglomerated SCN is larger than a single crystal but fluoresces at approximately the same wavelength.

Accordingly, the invention includes a method of preparing a conglomerated SCN. The method comprises washing a plurality of SCNs in a first solution, wherein the first solution comprises a nonpolar solvent, adding the washed SCNs to a second solution, wherein the second solution comprises a nonpolar solvent, and agitating the SCNs in the second solution. Either or both of the first and second solutions may further comprise a polar solvent.

The invention further includes a method of preparing a hydrophilic conglomerated SCN. The method comprises combining a conglomerated SCN and a first polymer, wherein the first polymer comprises a functional group, agitating the conglomerated SCN with the first polymer, and adding a second polymer and a crosslinking agent to the conglomerated SCN. The second polymer comprises a functional group that is capable of being crosslinked to the first polymer, and the crosslinking agent is one that is capable of crosslinking the first polymer to the second polymer.

Another embodiment of the invention includes a method of preparing a conglomerated SCN through crosslinking of SCNs with one or more polymers. The method comprises combining a plurality of SCNs and a first polymer, wherein each of the SCNs comprises a first functional group, and wherein the first polymer comprises a second functional group that is capable of being crosslinked to the first functional group, and adding a crosslinking agent to the plurality of SCNs and the first polymer. The crosslinking agent is one that is capable of crosslinking the first polymer to the SCNs. A second polymer can be added to further crosslink the SCNs and the first polymer.

Variations of the above preparation methods are included in the invention, as further described herein.

The invention also comprises conglomerated SCNs. For example, the invention comprises a composition comprising a population of conglomerated SCNs, wherein each conglomerated SCN of the population comprises a plurality of SCNs. Each SCN of the plurality interacts via a direct chemical association with at least one adjacent SCN of the conglomerate. Further, the conglomerated SCNs of the population have an average nanoparticle size, and each of the nanoparticle sizes is within about 20% of the average nanoparticle size. In some embodiments, each conglomerated SCN of the population comprises at least 10 SCNs; in other embodiments, each conglomerated SCN of the population comprises at least 100 SCNs. The population may comprise conglomerated SCNs that are crosslinked to a hydrophilic polymer, or may comprise conglomerated SCNs that are crosslinked to a biological agent. In some embodiments, each of the conglomerated SCNs of a population is conjugated to a different biological agent.

The invention also comprises methods of using conglomerated SCNs.

For example, the invention includes a method of detecting a target in a sample. The method comprises contacting a sample with a population of conglomerated SCNs, wherein the population comprises conglomerated SCNs that are conjugated to a biological agent. The biological agent specifically binds to a target in the sample. The method further comprises allowing the biological agent to specifically bind to the target and analyzing the sample via spectroscopy, thereby obtaining a spectroscopic signature of the sample. The spectroscopic signature is indicative of the presence or the absence of the target in the sample.

Additionally, the invention includes a method of detecting more than one target in a sample. The method comprises contacting a sample with a population of conglomerated SCNs wherein each of the conglomerated SCNs of the population is conjugated to a different biological agent and each of the biological agents specifically binds to a different target in the sample. The method further comprises allowing at least one biological agent to specifically bind to its target and analyzing the sample via spectroscopy, thereby obtaining a spectroscopic signature of the sample. The spectroscopic signature is indicative of the presence or absence of more than one target in the sample.

The invention also includes a method of detecting the location of a target within a sample comprising contacting the sample with a population of conglomerated SCNs, wherein the population comprises conglomerated SCNs that are conjugated to a biological agent. The biological agent specifically binds to a target in the sample. The method further comprises allowing the biological agent to specifically bind to the target and imaging the sample or a section thereof, thereby detecting the location of the target within the sample.

Another embodiment of the invention is a method of detecting the location of more than one target within a sample. The method comprises contacting the sample with a population of conglomerated SCNs, wherein each of the conglomerated SCNs of the population is conjugated to a different biological agent and each of the biological agents specifically binds to a different target in the sample. The method further comprises allowing the biological agents to specifically bind to the targets and imaging the sample or a section thereof, thereby detecting the location of the more than one target within the sample.

Variations of the methods of use are included in the invention, as described herein.

### DETAILED DESCRIPTION OF THE INVENTION

Methods of Preparing Conglomerated SCNs

The invention includes methods of making conglomerated SCNs. As described in more detail below, a “conglomerated SCN,” comprises a plurality of SCNs that have been made to pack or clump together into a single mass.

According to one embodiment of the present invention, semiconductor nanocrystals (SCNs) are used as a starting material to form conglomerated SCNs. The SCNs used as a starting reagent can be of any size, and can be uniform or nonuniform in size, as determined by the required properties of the final product. The SCNs may be prepared by a variety of methods known in the art, including but not limited to SCNs prepared by the methods described in U.S. provisional patent application Ser. No. 60/598,634, filed Aug. 4, 2004 (L. Qu), or those prepared according to the methods described in WO 2005/001889 (S. Nie and R. E. Bailey), both of which are hereby incorporated by reference in their entirety.

According to one embodiment of the invention, SCNs are washed in a first solution comprising a solvent, and separated from the solution by precipitating. The first solution comprises one or more nonpolar solvent(s). In some embodiments, the first solution comprises more than one nonpolar solvent. In other embodiments, the first solution comprises one or more nonpolar solvent(s) and one or more polar solvent(s). When the first solution comprises both nonpolar and polar solvents, the nonpolar solvent must be added to the crystals before adding the polar solvent. The nonpolar solvent or solvents may comprise any nonpolar solvent which can form a well dispersed nanocrystal suspension, for example, hexanes, toluene, or chloroform. The polar solvent or solvents may comprise any polar solvent capable of causing nanocrystals to precipitate out of the solution, for example, butanol or methanol.

In one embodiment, the first solution comprises a mixture of nonpolar and polar solvents. The first solution may comprise more than one nonpolar solvent and/or more than one polar solvent. In the case of a mixture of nonpolar and polar solvents, the ratio of nonpolar to polar solvents in the first solution can vary. The ratio of nonpolar to polar solvents in the first solution can range from 1:0 (i.e., 100% nonpolar solvent) to 1:4 (i.e., 20% nonpolar solvent). The ratio of nonpolar to polar solvent in the first solution may be, for example, about 1:1, 1:2, 1:3, 1:4, or fractional ratios between these values. As explained below, the ratio of nonpolar to polar solvent as well as the particular solvent used will determine the size of conglomerated SCNs obtained. In a preferred embodiment, the first solution comprises hexanes and methanol, and the ratio of hexanes to methanol is about 1:5.

According to the invention, the washed semiconductor nanocrystals are suspended in a second solution and agitated to form conglomerated SCNs. The second solution minimally comprises a nonpolar solvent, but may comprise a mixture of nonpolar and polar solvents. When the second solution comprises both nonpolar and polar solvents, the nonpolar solvent must be added to the crystals before adding the polar solvent. The nonpolar solvent may be any nonpolar solvent, for example, hexanes, toluene, or chloroform. The polar solvent may be any polar solvent, for example, butanol, ethanol, acetone, or methanol. The ratio of nonpolar to polar solvents in the second solution can vary and generally will range from 1:2 to 1:20, depending on the polarities of the nonpolar and polar solvents. Preferably, the ratio of nonpolar to polar solvents in the second solution is 1:5 to 1:20. In one embodiment, the nonpolar solvent used in the second solution is hexanes, the polar solvent used is butanol, and the ratio of hexanes to butanol is 1:20. In another embodiment, the nonpolar solvent used in the second solution is hexanes, the polar solvent is methanol, and the ratio of hexanes to methanol is 1:10.

The SCNs are suspended in the second solution and agitated. A variety of methods can be used to agitate the crystal suspension, for example, sonication, shaking, vibrating, or mixing. Agitation causes the crystals to pack or clump together into conglomerated SCNs.

The type and amount of solvents used in the present invention will influence the size of the conglomerated SCNs obtained by the methods. For example, use of a more polar solution in either step causes larger conglomerated SCNs to form, while use of a more nonpolar solution will cause smaller conglomerated SCNs to form. By controlling the first and second solutions' polarity, one can control the relative size of conglomerated SCNs obtained in a single conglomerated SCN preparation.

Conglomerated SCNs made from hydrophobic SCNs are hydrophobic, which can make their use in hydrophilic systems problematic. Conglomerated SCNs can be made hydrophilic by another method of the present invention, by which conglomerated SCNs are encased within a hydrophilic polymer “cage.” According to the method, a conglomerated SCN suspension is agitated with a first polymer comprising a functional group. The functional group may be any group that can be crosslinked to a functional group on a second polymer. Examples of functional groups include, without limitation, COOH, OH, NH₂ and SH groups. The first polymer may be, for example, any long chain hydrocarbon comprising an appropriate functional group. Following agitation with the first polymer, the conglomerated SCNs are washed to remove any unassociated first polymer. A second polymer comprising a functional group that can be crosslinked to a functional group of the first polymer is then added. A crosslinking reagent is added to crosslink the first and second polymers to each other.

In one embodiment, the first polymer is poly(allylamine) (PAA)(CAS # 30551-89-4). According to this embodiment, conglomerated SCNs are suspended in a solution comprising PAA. The suspension is agitated for 20 minutes, and the conglomerated SCNs are washed with PBS. A second polymer that can link to a functional group on PAA is added, e.g., one that includes an amino group, and EDC (1-Ethyl-3-[3-dimethylaminopropyl]carbodiimide hydrochloride) is added to crosslink the PAA to the second polymer. According to the method, the first polymer forms a hydrophilic “cage” around the conglomerated SCNs, resulting in conglomerated SCNs that are hydrophilic or water-soluble. That is, the first polymer associates with the conglomerated SCNs, for example, by hydrophobic interactions, and crosslinks to the second polymer. The crosslinked polymers enclose the conglomerated SCNs in a polymer “cage.” As will be understood by one skilled in the art, a variety of polymers can be selected, as long as they are capable of surrounding the conglomerated SCNs with crosslinking. An example of a second polymer that can be used in the method is sodium polyacrylate.

According to another method of the invention, conglomerated SCNs are prepared using water soluble SCNs as a starting reagent. According to the method, a polymer comprising a functional group that can be crosslinked directly to the SCNs is added to a solution of water soluble SCNs. The polymer is then crosslinked to the SCNs. The polymer may be further crosslinked to itself. One or more additional polymers may be added to facilitate crosslinking. The conglomerated SCNs produced by this method are held together by covalent bonds between the polymer and SCNs, and between the polymer molecules. The size of conglomerated SCNs produced by this method can be controlled by altering the type and amount of polymer added to the reaction. The resulting conglomerated SCNs can be from about 20 to several hundred nanometers in diameter. A given preparation of conglomerated SCNs prepared according to this method typically has a size distribution of about 10%. In a preferred embodiment, water soluble SCNs comprising carboxylic acid groups are combined with PAA and EDC to produce conglomerated SCNs.

Conglomerated SCN Compositions

The invention includes conglomerated SCNs. A “conglomerated SCN” comprises a plurality of SCNs that have been made to pack together into a single mass. Within a conglomerated SCN, one or more chemical interactions between semiconductor nanocrystals (e.g., dipole-dipole, hydrophobic, hydrophilic, covalent bonds) stabilize the nanocrystals in tight associations. In a preferred embodiment, adjacent SCNs within a conglomerated SCN directly associate with one another via dipole-dipole interactions. In another preferred embodiment, a conglomerated SCN comprises a plurality of SCNs, and each SCN of the plurality of SCNs interacts via a direct chemical association with at least one adjacent SCN of the conglomerate. In yet another preferred embodiment, SCNs are further stabilized by crosslinking between SCNs and polymers.

An individual conglomerated SCN may comprise from about two to several hundred nanocrystals. In a preferred embodiment, an individual conglomerated SCN comprises at least about ten nanocrystals. In one embodiment, an individual conglomerated SCN comprises up to about 100 nanocrystals. In another embodiment, an individual conglomerated SCN comprises up to about 200 nanocrystals. In yet another embodiment, an individual conglomerated SCN comprises up to about 300 nanocrystals.

A single preparation of conglomerated SCNs comprises conglomerated SCNs with a relatively narrow range of nanoparticle number per conglomerated SCN. That is, conglomerated SCNs in a single preparation will tend to form with nanoparticle numbers that are within 20% of an average nanoparticle number per conglomerated SCN. Accordingly, one embodiment of the invention comprises a population of conglomerated SCNs, wherein each conglomerated SCN of the population comprises a plurality of semiconductor nanocrystals, wherein each semiconductor nanocrystal of the plurality interacts via a direct chemical association with at least one adjacent semiconductor nanocrystal of the conglomerate, wherein the conglomerated SCNs of the population have an average nanoparticle size, and wherein each of the nanoparticle sizes is within about 20% of the average nanoparticle size.

The nanoparticle number in a single conglomerate SCN will vary depending on the type(s) of SCN or SCNs used as a starting reagent, the type of solvent(s) used in the preparation steps, and the final polarity of solvents used in preparation. Preferably, the conglomerated SCNs in a given preparation will have individual nanoparticle numbers that are within from about 5-20% of the average nanoparticle number of conglomerated SCNs in the preparation. More preferably, the conglomerated SCNs in a given preparation will have individual nanoparticle numbers that are within from about 5-10% of the average nanoparticle number of conglomerated SCNs in the preparation. For example, if the sizes of a given preparation are within 20% of an average nanoparticle number, a conglomerated SCN preparation with an average conglomerated SCN nanoparticle number of 100 will have conglomerated SCNs ranging from about 80-120 SCNs; a preparation with an average nanoparticle number of 200 will have conglomerated SCNs ranging from about 160-240 SCNs; and a preparation with an average nanoparticle number of 300 will have conglomerated SCNs ranging from about 240-360 SCNs, etc.

The emission spectra of the particles in a conglomerated SCN are not altered by conglomeration. That is, the emission spectra of particles used as a starting material to make a conglomerated SCN are retained in the conglomerated SCN. Conglomerated SCNs have a fluorescence signal that is much stronger than the signal strength of single particles used to make conglomerated SCNs.

The conglomerated SCNs of the present invention can be conjugated to a biological agent. By “conjugated” as used herein means that the conglomerated SCN is attached to a biological agent through any means, e.g., chemical bonds, electrostatic interactions, cross-linkers, and the like. As used herein the term “biological agent” refers to any molecule, entity, or part of either of the foregoing that is endogenous to a whole organism and/or is biologically active within a whole organism. Suitable biological agents for conjugation to the conglomerated SCNs of the invention are known in the art and include, for instance, a biomolecule or a drug. Preferably, the biological agent is a biomolecule, wherein “biomolecule” refers to any molecule or part thereof that is naturally-occurring within or on the body of a whole organism. Preferred biomolecules for conjugation to the conglomerated SCNs of the invention include a protein, a peptide, a nucleic acid molecule, a combination thereof, and the like. Also preferred is that the biological agent is a drug, wherein “drug” as used herein refers to any chemical agent that is exogenous to the body of a whole organism and typically is synthesized by means known in the art. The conglomerated SCNs described herein can be conjugated to any drug. The drug may or may not be therapeutically effective to any organism. In this regard, the conglomerated SCNs of the invention may be conjugated to a candidate drug wherein one of ordinary skill in the appropriate art reasonably believes that the candidate drug may have a therapeutic or beneficial effect to any whole organism.

The conglomerated SCNs of the invention may be attached to or embedded within a substrate or solid support. Solid supports of various compositions are known in the art, including supports of glass, plastic, polymers, etc. A variety of support structures are known in the art, including, for example, polymer beads, spheres or microspheres, plates, optical fibers or optical fiber bundles.

The present invention includes a population of conglomerated SCNs. A population of conglomerated SCNs can comprise conglomerated SCNs obtained from a single preparation of conglomerated SCNs, or can comprise conglomerated SCNs obtained from multiple preparations. That is, a conglomerated SCN population may have conglomerated SCNs of the same or different sizes and emission spectra. A population of conglomerated SCNs can have a broad or narrow size distribution range, and may comprise conglomerated SCNs each conjugated to the same or different biological agents, such that each biological agent corresponds to a conglomerated SCN having either the same or a unique emission spectrum. In one embodiment, a population comprises SCNs with emission spectra ranging from about 400 nm to about 900 nm. The emission spectrum of a given population of SCNs can be designed to meet the requirements of a particular application, e.g., a biological or biomedical application.

The conglomerated SCNs described herein can be formed by conglomerating different nanocrystals with different emission wavelengths into a single conglomerated SCN. The resulting conglomerated SCNs provide powerful multiplexing tools for a variety of methods, for example, biological or biomedical applications including drug discovery, drug delivery and gene expression analyses.

The conglomerated SCNs described herein can be formed as a composition, such as a pharmaceutical composition. Pharmaceutical compositions containing conglomerated SCNs can comprise more than one active ingredient, such as more than one conglomerated SCN conjugated to a different biological agent. The pharmaceutical composition can alternatively comprise a conglomerated SCN in combination with pharmaceutically active agents or drugs other than those conjugated to them.

Compositions comprising the conglomerated SCNs can comprise a carrier, a diluent, or an excipient. The carrier can be any suitable carrier. Preferably, the carrier is a pharmaceutically acceptable carrier. With respect to pharmaceutical compositions, the carrier can be any of those conventionally used and is limited only by chemico-physical considerations, such as solubility and lack of reactivity with the active compound(s), and by the route of administration. It will be appreciated by one of skill in the art that, in addition to the following described pharmaceutical composition, the conglomerated SCNs of the invention can be formulated as inclusion complexes, such as cyclodextrin inclusion complexes, or liposomes.

The pharmaceutically acceptable carriers described herein, for example, vehicles, adjuvants, excipients, and diluents, are well-known to those skilled in the art and are readily available to the public. It is preferred that the pharmaceutically acceptable carrier be one which is chemically inert to the active agent (s) and one which has no detrimental side effects or toxicity under the conditions of use.

The choice of carrier will be determined in part by the particular conglomerated SCN and biological agent conjugated thereto, as well as by the particular method used to administer the compound, inhibitor, or combination of compound and inhibitor. Accordingly, there are a variety of suitable formulations of the pharmaceutical composition of the present inventive methods. The following formulations for oral, aerosol, parenteral, subcutaneous, intravenous, intramuscular, interperitoneal, rectal, and vaginal administration are exemplary and are in no way limiting. One skilled in the art will appreciate that these routes of administering the conglomerated SCNs of the present invention are known, and, although more than one route can be used to administer a particular conglomerated SCN, a particular route can provide a more immediate and more effective response than another route.

Injectable formulations are among those formulations that are preferred in accordance with the present invention. The requirements for effective pharmaceutical carriers for injectable compositions are well-known to those of ordinary skill in the art (see, e.g., Pharmaceutics and Pharmacy Practice, J.B. Lippincott Company, Philadelphia, Pa., Banker and Chalmers, eds., pages 238-250 (1982), and ASEP Handbook on Injectable Drugs, Toissel, 4th ed., pages 622-630 (1986)).

Topical formulations are well-known to those of skill in the art. Such formulations are particularly suitable in the context of the present invention for application to the skin.

Formulations suitable for oral administration can consist of (a) liquid solutions, such as an effective amount of the conglomerated SCN dissolved in diluents, such as water, saline, or orange juice; (b) capsules, sachets, tablets, lozenges, and troches, each containing a predetermined amount of the active ingredient, as solids or granules; (c) powders; (d) suspensions in an appropriate liquid; and (e) suitable emulsions. Liquid formulations may include diluents, such as water and alcohols, for example, ethanol, benzyl alcohol, and the polyethylene alcohols, either with or without the addition of a pharmaceutically acceptable surfactant. Capsule forms can be of the ordinary hard-or soft-shelled gelatin type containing, for example, surfactants, lubricants, and inert fillers, such as lactose, sucrose, calcium phosphate, and corn starch. Tablet forms can include one or more of lactose, sucrose, mannitol, corn starch, potato starch, alginic acid, microcrystalline cellulose, acacia, gelatin, guar gum, colloidal silicon dioxide, croscarmellose sodium, talc, magnesium stearate, calcium stearate, zinc stearate, stearic acid, and other excipients, colorants, diluents, buffering agents, disintegrating agents, moistening agents, preservatives, flavoring agents, and pharmacologically compatible excipients. Lozenge forms can comprise the active ingredient in a flavor, usually sucrose and acacia or tragacanth, as well as pastilles comprising the active ingredient in an inert base, such as gelatin and glycerin, or sucrose and acacia, emulsions, gels, and the like containing, in addition to the active ingredient, such excipients as are known in the art.

The conglomerated SCNs, alone or in combination with each other and/or with other suitable components, can be made into aerosol formulations to be administered via inhalation. These aerosol formulations can be placed into pressurized acceptable propellants, such as dichlorodifluoromethane, propane, nitrogen, and the like. They also may be formulated as pharmaceuticals for non-pressured preparations, such as in a nebulizer or an atomizer. Such spray formulations also may be used to spray mucosa.

Formulations suitable for parenteral administration include aqueous and non-aqueous, isotonic sterile injection solutions, which can contain anti-oxidants, buffers, bacteriostats, and solutes that render the formulation isotonic with the blood of the intended recipient, and aqueous and non-aqueous sterile suspensions that can include suspending agents, solubilizers, thickening agents, stabilizers, and preservatives. The conglomerated SCNs can be administered in a physiologically acceptable diluent in a pharmaceutical carrier, such as a sterile liquid or mixture of liquids, including water, saline, aqueous dextrose and related sugar solutions, an alcohol, such as ethanol, isopropanol, or hexadecyl alcohol, glycols, such as propylene glycol or polyethylene glycol, dimethylsulfoxide, glycerol ketals, such as 2,2-dimethyl-1,3-dioxolane-4-methanol, ethers, such as poly(ethyleneglycol) 400, an oil, a fatty acid, a fatty acid ester or glyceride, or an acetylated fatty acid glyceride with or without the addition of a pharmaceutically acceptable surfactant, such as a soap or a detergent, suspending agent, such as pectin, carbomers, methylcellulose, hydroxypropylmethylcellulose, or carboxymethylcellulose, or emulsifying agents and other pharmaceutical adjuvants.

Oils, which can be used in parenteral formulations include petroleum, animal, vegetable, or synthetic oils. Specific examples of oils include peanut, soybean, sesame, cottonseed, corn, olive, petrolatum, and mineral. Suitable fatty acids for use in parenteral formulations include oleic acid, stearic acid, and isostearic acid. Ethyl oleate and isopropyl myristate are examples of suitable fatty acid esters.

Suitable soaps for use in parenteral formulations include fatty alkali metal, ammonium, and triethanolamine salts, and suitable detergents include (a) cationic detergents such as, for example, dimethyl dialkyl ammonium halides, and alkyl pyridinium halides, (b) anionic detergents such as, for example, alkyl, aryl, and olefin sulfonates, alkyl, olefin, ether, and monoglyceride sulfates, and sulfosuccinates, (c) nonionic detergents such as, for example, fatty amine oxides, fatty acid alkanolamides, and polyoxyethylenepolypropylene copolymers, (d) amphoteric detergents such as, for example, allcyl-b-arninopropionates, and 2-alkyl-imidazoline quaternary ammonium salts, and (e) mixtures thereof

Parenteral formulations will typically contain from about 0.5% to about 25% by weight of the active ingredient in solution. Preservatives and buffers may be used. In order to minimize or eliminate irritation at the site of injection, such compositions may contain one or more nonionic surfactants having a hydrophile-lipophile balance (HLB) of from about 12 to about 17. The quantity of surfactant in such formulations will typically range from about 5% to about 15% by weight. Suitable surfactants include polyethylene sorbitan fatty acid esters, such as sorbitan monooleate and the high molecular weight adducts of ethylene oxide with a hydrophobic base, formed by the condensation of propylene oxide with propylene glycol. The parenteral formulations can be presented in unit-dose or multi-dose sealed containers, such as ampoules and vials, and can be stored in a freeze-dried (lyophilized) condition requiring only the addition of the sterile liquid excipient, for example, water, for injections, immediately prior to use. Extemporaneous injection solutions and suspensions can be prepared from sterile powders, granules, and tablets of the kind previously described.

Additionally, the conglomerated SCNs, can be made into suppositories by mixing with a variety of bases, such as emulsifying bases or water-soluble bases. Formulations suitable for vaginal administration can be presented as pessaries, tampons, creams, gels, pastes, foams, or spray formulas containing, in addition to the active ingredient, such carriers as are known in the art to be appropriate.

One of ordinary skill in the art will readily appreciate that the conglomerated SCNs of the present invention can be modified in any number of ways, such that the efficacy of the conglomerated SCNs is increased through the modification. For instance, the conglomerated SCN or the biological agent conjugated thereto could be conjugated either directly or indirectly through a linker to a targeting moiety. The practice of conjugating nanocrystals or biological agents to targeting moieties is known in the art. See, for instance, Wadwa et al., J. Drug Targeting 3: 111 (1995), and U.S. Pat. No. 5,087,616. The term “targeting moiety” as used herein, refers to any molecule or agent that specifically recognizes and binds to a cell-surface receptor, such that the targeting moiety directs the delivery of the conglomerated SCN and/or biological agent to a population of cells on which surface the receptor is expressed. Targeting moieties include, but are not limited to, antibodies, or fragments thereof, peptides, hormones, growth factors, cytokines, and any other naturally- or non-naturally-existing ligands, which bind to cell surface receptors. The term “linker” as used herein, refers to any agent or molecule that bridges the conglomerated SCN or biological agent to the targeting moiety. One of ordinary skill in the art recognizes that sites on the conglomerated SCN or biological agent, which are not necessary for the function of the conglomerated SCN or biological agent, are ideal sites for attaching a linker and/or a targeting moiety, provided that the linker and/or targeting moiety, after attached to the conglomerated SCN or biological agent, do(es) not interfere with the function of the conglomerated SCN or biological agent, i.e., the ability to absorb and emit detectable energy or specifically bind to a target or targets.

Alternatively, the conglomerated SCN of the present invention can be modified into a depot form, such that the manner in which the conglomerated SCN is released into the body to which it is administered is controlled with respect to time and location within the body (see, for example, U.S. Pat. No. 4,450,150). Depot forms of conglomerated SCNs can be, for example, an implantable composition comprising the conglomerated SCN and a porous material, such as a polymer, wherein the conglomerated SCN is encapsulated by or diff-used throughout the porous material. The depot is then implanted into the desired location within the body and the conglomerated SCN is released from the implant at a predetermined rate by diffusing through the porous material.

Furthermore, the present inventive methods can comprise the administration of the conglomerated SCN(s), in the presence or absence of an agent that enhances its efficacy, or the methods can further comprise the administration of other suitable components, such as those that can protect the conglomerated SCN, the biological agent, or both from degradation within the host or those that can prevent the elimination from the host or cellular uptake of the conglomerated SCN.

For purposes of the present invention, the amount or dose of the conglomerated SCN(s) administered should be sufficient to effect a response in the animal over a reasonable time frame. Particularly, the dose of the conglomerated SCN should be sufficient to allow the biological agent(s) to specifically bind to its target(s) within about 1-2 hours, if not 3-4 hours, from the time of administration. The dose will be determined by the efficacy of the particular conglomerated SCN, biological agent, or both conjugated thereto and the condition of the animal (e.g., human), as well as the body weight of the animal (e.g., human) to be treated. Many assays for determining an administered dose are known in the art. For purposes of the present invention, an assay, which comprises comparing the extent to which the biological agent(s) specifically bind(s) to its target(s) within the host upon administration of a given dose of a conglomerated SCN to a mammal among a set of mammals that are each given a different dose of the conglomerated SCN(s), could be used to determine a starting dose to be administered to a mammal. The extent to which the biological agent conjugated to the conglomerated SCN specifically binds to the target within the host upon administration of a certain dose can be determined through imaging the host or a section thereof

The dose also will be determined by the existence, nature and extent of any adverse side effects that might accompany the administration of a particular conglomerated SCN. Ultimately, the treating physician will decide the dosage of the compound or inhibitor of the present invention with which to treat each individual patient, taking into consideration a variety of factors, such as age, body weight, general health, diet, sex, conglomerated SCN to be administered, and route of administration.

In addition to the present inventive methods of using the conglomerated SCNs or populations of conglomerated SCNs described herein, the conglomerated SCNs can be used in optoelectronic methods or as optoelectronic devices. For example, the conglomerated SCNs can be used as light emitting diodes or as solar cells. See, e.g., Huynh, et al., Advanced Functional Materials, 13: 73-79 (2003), Milliron, et al., Advanced Materials, 15: 58-61 (2003), Schlamp, et al., Journal of Applied Physics, 82, 5837-5842 (1997). The conglomerated SCNs can be used in lieu of bulk materials when the bulk materials with the desired electronic properties are not available. In this instance, the conglomerated SCNs would be arranged and deposited onto a substrate, for example, in an array as a thin film or layers of thin films on a support substrate or as a coating on or around another electronic material. Subsequently the support substrate and layered conglomerated SCN film or other coated electronic material can be processed as needed in similar fashion to bulk semiconductor materials with the unique properties of the conglomerated SCN for use in electronic and optoelectronic devices.

Methods of Use

The conglomerated SCNs of the invention are useful in a number of in vitro and in vivo methods, particularly in the instance that the conglomerated SCNs are conjugated to a biological agent, such as a biomolecule. In this regard, the present invention provides a method of detecting a target in a sample. The method comprises (i) contacting a sample with a conglomerated SCN which is conjugated to a biological agent, wherein the biological agent specifically binds to a target in the sample, (ii) allowing the biological agent to specifically bind to the target, and (iii) analyzing the sample via spectroscopy (e.g., fluorescence spectrophotometry, fluorescence microscopy, flow cytometry), thereby obtaining a spectroscopic signature of the sample, wherein the spectroscopic signature is indicative of the presence or the absence of the target in the sample. As used herein, the term “in vitro” means that the method does not take place within a host. As used herein, the term “in vivo” means that the method takes place within a host or any part thereof.

As used herein, the term “target” refers to any entity that specifically binds to a biological agent conjugated to a conglomerated SCN. The target can be, for instance, a protein, a nucleic acid molecule, a fragment of either of the foregoing, a small-molecule drug, a cell, a tissue, or a drug metabolite. Suitable targets that are proteins include, but are not limited to, antibodies, or fragments thereof, peptides, hormones, growth factors, cytokines, tumor-associated proteins, cell-surface receptors, coagulation factors, proteins associated with a disease or a condition, and the like. One of ordinary skill in the art realizes that the phrase “specifically binds to” generally means that the binding occurs in such a manner that excludes the binding of most other entities within the sample or host. A target-biological agent binding interaction typically has a dissociation constant, KD, within the range of about micromolars to about picomolars.

With respect to the present methods, i.e., the method of detecting a target in a sample, the method of detecting more than one target in a sample, and the method of monitoring a biological process in vitro, the sample can be any sample, such as blood, lymph, ductal fluid, tissue, cell cultures, a single cell, urine, a biopsy, and the like. The sample can be obtained from any source, such as a host, an animal, a cultured cell line, a plant, and a tumor. In one embodiment of the invention, the source can represent a normal, undiseased state. Alternatively, the source, such as a mammal, has a disease or a condition, such that the method achieves detection or prognosis of the disease or the condition. In a preferred embodiment of the invention, the disease is cancer including, but not limited to, lung cancer, brain cancer, ovarian cancer, uterine cancer, testicular cancer, lymphoma, leukemia, stomach cancer, pancreatic cancer, skin cancer, breast cancer, adenocarcinoma, glioma, bone cancer, and the like. The present inventive methods of detecting cancer are particularly useful for detecting skin and breast tumors that are located close to the skin surface.

In some of the methods described herein, a sample is analyzed via spectroscopy in order to obtain a spectroscopic signature. By “spectroscopy” as used herein is meant any technique for analyzing molecules based on how they absorb radiation. One of ordinary skill in the art realizes that many methods of spectroscopy are known in the art, including, for instance, ultraviolet-visible (IJV-VIS) spectroscopy, infrared (IR) spectroscopy, fluorescence spectroscopy, Raman spectroscopy, mass spectrometry, and nuclear magnetic resonance (NMR). For the present inventive methods, the sample preferably is analyzed via fluorescence spectroscopy. More preferably, the sample is analyzed via visible to infrared fluorescence spectroscopy and, most preferably, the sample is analyzed via far-red and near-infrared fluorescence. The term “spectroscopic signature” as used herein refers to a resulting pattern, plot, or spectrum obtained upon performing spectroscopy on a sample. The spectroscopic signature obtained of a sample containing a biological agent bound to a target can be compared to a control spectroscopic signature, wherein the target is not present in the sample or host.

The present invention also provides a method of detecting the location of a target within a sample. The method comprises (i) contacting a sample with a conglomerated SCN which is conjugated to a biological agent, wherein the biological agent specifically binds to a target in the sample, (ii) allowing the biological agent to specifically bind to the target, and (iii) imaging the sample or a section thereof, thereby detecting the location of the target within the sample.

The location of the target is determined via imaging the sample with the conjugated conglomerated SCN bound to the target. Many methods of imaging are known in the art, including, for example, x-ray computed tomography (CT), magnetic resonance imaging (MRI), positron emission tomography (PET), and optical imaging. The imaging may be done via fluorescence. For example, the imaging may be done via visible to infrared fluorescence or through far-red and near-infrared fluorescence. The conglomerated SCNs discussed herein can have emission peak wavelengths that are within the near infrared spectrum or far red spectrum. In this regard, methods requiring imaging of conglomerated SCNs can involve detection of near infrared or far red emission peak wavelengths. This allows imaging of targets deep within a host or animal.

Also provided by the present invention is a method of monitoring a biological process in vitro. The method comprises (i) contacting a sample with a conglomerated SCN which is conjugated to a biological agent, wherein the biological agent specifically binds to a target in the sample, wherein the target functions in a biological process, (ii) allowing the biological agent to specifically bind to the target, and (iii) imaging the sample or a section thereof over a period of time or before and after a stimulus, thereby monitoring a biological process in vitro.

The present invention provides a method of detecting the location of a target in vivo. The method comprises (i) administering to a host a conglomerated SCN which is conjugated to a biological agent, wherein the biological agent specifically binds to a target in the-host, (ii) allowing the biological agent to specifically bind to the target, (iii) imaging the host, a section thereof, or a cell thereof, thereby detecting the location of the target in vivo.

The present invention provides a method of monitoring a biological process in vivo. The method comprises (i) administering to a host a conglomerated SCN which is conjugated to a biological agent, wherein the biological agent specifically binds to a target in the host, wherein the target functions in a biological process, (ii) allowing the biological agent to specifically bind to the target, and (iii) imaging the host, a section, or a cell thereof over a period of time or before and after a stimulus, thereby monitoring a biological process in vivo.

One of ordinary skill in the art appreciates that use of any of the conglomerated SCNs of the invention can provide simultaneous detection or monitoring of more than one target. In this regard, conglomerated SCNs of the invention are useful in a number of in vitro and in vivo methods, especially in the case that each conglomerated SCN in a given population may be conjugated to a different biological agent, such that each of the different biological agents corresponds to a conglomerated SCN having a unique emission spectrum. In this regard, the present invention also provides a method of detecting more than one target in a sample. The method comprises (i) contacting a sample with a population of conglomerated SCNs, wherein the population of conglomerated SCNs comprises conglomerated SCNs each conjugated to a different biological agent, wherein each of the biological agents specifically binds to a different target in the sample, (ii) allowing the biological agents to specifically bind to the targets, and (iii) analyzing the sample via spectroscopy, thereby obtaining a spectroscopic signature of the sample, wherein the spectroscopic signature is indicative of the presence or absence of the more than one target in the sample.

The present invention also provides a method of detecting the location of more than one target within a sample. The method comprises (i) contacting a sample with a population of conglomerated SCNs, wherein the population of conglomerated SCNs comprises conglomerated SCNs each conjugated to a different biological agent, wherein each of the biological agents specifically binds to a different target in the sample, (ii) allowing the biological agents to specifically bind to the targets, (iii) imaging the sample or a section thereof, thereby detecting the location of the more than one target within the sample.

The present invention also provides method of detecting multiple targets within a sample. The method comprises (i) contacting a sample with a population of conglomerated SCNs prepared by conglomerating different nanocrystals with different emission wavelengths and different intensities into single conglomerated SCNs, each type of SCN conjugated to a different biological agent, wherein each of the biological agents specifically binds to a different target in the sample, (ii) allowing the biological agents to specifically bind to the targets, (iii) detecting the signal from the sample or a section thereof, thereby detecting the presence of the more than one target within the sample.

Further provided by the present invention is a method of monitoring a biological process in vitro. The method comprises (i) contacting a sample with a population of conglomerated SCNs, wherein the population of conglomerated SCNs comprises conglomerated SCNs each conjugated to a different biological agent, wherein each of the biological agents specifically binds to a different target in the sample, wherein each of the targets functions in a biological process, (ii) allowing the-biological agents to specifically bind to the targets, and (iii) imaging the sample or a section thereof over a period of time or before and after a stimulus, thereby monitoring a biological process in vitro.

A method of detecting the location of more than one target in vivo is provided by the present invention. The method comprises (i) administering to a host a population of conglomerated SCNs, wherein the population of conglomerated SCNs comprises conglomerated SCNs each conjugated to a different biological agent, wherein each of the biological agents specifically binds to a different target in the host, (ii) allowing the biological agents to specifically bind to the targets, (iii) imaging the host, a section thereof, or a cell thereof, thereby detecting the location of the more than one target in vivo.

The present invention also provides a method of monitoring a biological process in vivo. The method comprises (i) administering to a host a population of conglomerated SCNs, wherein the population of conglomerated SCNs comprises conglomerated SCNs each conjugated to a different biological agent, wherein each of the biological agents specifically binds to a different target in the host, wherein each of the targets functions in a biological process, (ii) allowing the biological agents to specifically bind to the targets, and (iii) imaging the host, a sample thereof, or a section thereof over a period of time or before and after a stimulus, thereby monitoring a biological process in vivo.

### EXAMPLE 1

SCNs (20 mg, CdSe-ZnS) were purified by washing three times with 5 mL hexanes and 30 mL MeOH, and centrifuging at 2,000 G for 10 minutes. Hexanes were added to the SCNs before adding the MeOH. The crystals were dissolved in 2 mL hexanes; 40 mL BuOH was then added. The solution was placed in a sonic washer for 10 minutes.

### EXAMPLE 2

10 mL of the conglomerated SCNs of Example 1 was treated with 100 μL undiluted PAA (CAS # 30551-89-4). The solution was sonicated for 10 minutes, centrifuged at 10,400 G for 10 minutes, and suspended in 1 mL 1× PBS.

### EXAMPLE 3

One ml of the suspension from Example 2 was placed in a 10 ml centrifuge tube and diluted to 5 ml with PBS buffer. Undiluted PAA (100 μL) (CAS # 30551-89-4) and EDC (0.2 ml, 10 mg/ml in PBS solution) were added and the solution was mixed at room temperature for 2 hours. The conglomerated SCNs were centrifuged at 2,000 G for 20 minutes.

What is claimed is:

1. A method of preparing a conglomerated SCN comprising:
washing a plurality of SCNs in a first solution, wherein said first solution comprises a nonpolar solvent;
adding said washed SCNs to a second solution, wherein said second solution comprises a nonpolar solvent; and
agitating said SCNs in said second solution.

2. The method of claim 1 wherein said first solution further comprises a polar solvent.

3. The method of claim 1 wherein said second solution further comprises a polar solvent.

4. The method of claim 1 wherein said first solution comprises hexanes and methanol, and wherein the ratio of hexanes to methanol is about 1:5.

5. The method of claim 1 wherein said second solution comprises hexanes and butanol, and wherein the ratio of hexanes to butanol is 1:20.

6. A method of preparing a hydrophilic conglomerated SCN, the method comprising:
combining a conglomerated SCN and a first polymer, wherein said first polymer comprises a functional group;
agitating said conglomerated SCN with said first polymer; and
adding a second polymer and a crosslinking agent to said conglomerated SCN, wherein said second polymer comprises a functional group that is capable of being crosslinked to said first polymer, and wherein said crosslinking agent is capable of crosslinking said first polymer to said second polymer.

7. The method of claim 6 further comprising washing said conglomerated SCN following agitation of said conglomerated SCN with said first polymer.

8. The method of 6 wherein said first polymer is PAA.

9. A method of preparing a conglomerated SCN comprising:
combining a plurality of SCNs and a first polymer, wherein each of said SCNs comprises a first functional group, and wherein said first polymer comprises a second functional group that is capable of being crosslinked to said first functional group; and
adding a crosslinking agent to said plurality of SCNs and said first polymer, wherein said crosslinking agent is capable of crosslinking said first polymer to said SCNs.

10. The method of claim 9, further comprising adding a second polymer to said SCNs and said first polymer.

11. The method of claim 9, wherein said first functional group is a hydrophilic functional group.

12. A composition comprising a population of conglomerated SCNs, wherein each conglomerated SCN of said population comprises a plurality of semiconductor nanocrystals, wherein each semiconductor nanocrystal of said plurality interacts via a direct chemical association with at least one adjacent semiconductor nanocrystal of said conglomerate, wherein the conglomerated SCNs of said population have an average nanoparticle size, and wherein each of said nanoparticle sizes is within about 20% of said average nanoparticle size.

13. The composition of claim 12, wherein each conglomerated SCN of said population comprises at least 10 semiconductor nanocrystals.

14. The composition of claim 12, wherein each conglomerated SCN of said population comprises at least 100 semiconductor nanocrystals.

15. The composition of claim 12, wherein said population comprises conglomerated SCNs that are crosslinked to a hydrophilic polymer.

16. The composition of claim 12, wherein said population comprises conglomerated SCNs that are crosslinked to a biological agent.

17. The composition of claim 16, wherein the biological agent is a biomolecule.

18. The composition of claim 16, wherein the biological agent is a drug.

19. The composition of claim 17, wherein the biomolecule is selected from the group consisting of a protein, a peptide, a nucleic acid molecule, and a combination thereof

20. The composition of claim 16, wherein said each of said conglomerated SCNs of said population is conjugated to a different biological agent.

21. A method of detecting a target in a sample comprising:
contacting a sample with the composition of claim 16, wherein the biological agent specifically binds to a target in the sample;
allowing the biological agent to specifically bind to the target; and
analyzing the sample via spectroscopy, thereby obtaining a spectroscopic signature of the sample, wherein the spectroscopic signature is indicative of the presence or the absence of the target in the sample.

22. A method of detecting more than one target in a sample comprising:
contacting a sample with the composition of claim 20, wherein each of the biological agents specifically bind to a different target in the sample;
allowing at least one biological agent to specifically bind to its target; and
analyzing the sample via spectroscopy, thereby obtaining a spectroscopic signature of the sample, wherein the spectroscopic signature is indicative of the presence or absence of more than one target in the sample.

23. A method of detecting the location of a target within a sample comprising:
contacting the sample with the composition of claim 16, wherein the biological agent specifically binds to a target in the sample;
allowing the biological agent to specifically bind to the target; and
imaging the sample or a section thereof, thereby detecting the location of the target within the sample.

24. A method of detecting the location of more than one target within a sample comprising:
contacting the sample with the composition of claim 20, wherein each of the biological agents specifically binds to a different target in the sample;
allowing the biological agents to specifically bind to the targets; and
imaging the sample or a section thereof, thereby detecting the location of the more than one target within the sample.
